(19) United States
(12) Patent Application Publication
(10) Pub. No.: US 2008/0060081 A1
(43) Pub. Date: Mar. 6, 2008

(54) State Info in Drm Identifier for Ad Drm

(75) Inventor: Sebastiaan Antonius Fransiscus Arnoldus Van Den Heuvel, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,595

(22) PCT Filed: Jun. 17, 2005
(86) PCT No.: PCT/IB05/52000

§ 371 Date: Dec. 14, 2006

(30) Foreign Application Priority Data
Jun. 22, 2004 (EP) 04102879.6

(51) Int. Cl. H04L 9/32

(52) U.S. Cl. 726/27

(57) ABSTRACT

This invention relates to a method and a device providing a content listing comprising a data structure (200) comprising a content listing (CDS) representing a number of media content items (100), where a media content item (100) is represented two times by a first (DRM id(s)) and a second (Dom.ID) representation if the media content item (100) belongs to a specific Digital Rights Management system (DRM) (300; 400) protecting the media content item (100). The first representation (DRM id(s)) comprises an identifier of the type of Digital Rights Management system (DRM) (300; 400) that protects the media content item (100), and the second representation (Dom.ID) comprises the first representation and additional information relating to the identification and/or a state of the specific Digital Rights Management system (DRM) (300; 400) that the media content item (100) belongs to. Hereby, handling of access to a given content item when the given rights related to a content item may differ depending on the state or situation of the DRM content is obtained, since information relating to this may be implemented in the second (or additional)representation. Additionally, it is also possible to provide a single implementation (comprising at least two representations) that can be handled as optimally as possible by both aware and unaware control points.

The invention relates to a content media method. The invention further relates to a content media device. Further, the invention relates to a computer readable medium having stored thereon instructions for causing one or more processing units to execute the method according to the invention.

Recent developments in content distribution technologies (i.e. the Internet and removable media) make it much easier to exchange content than ever before. The rapid adoption by consumers shows that such technologies really address their needs. The content providers want protection for the copyright of the content/content item(s) that is brought into digital circulation. Therefore in recent years, the amount of content protection systems is growing in a rapid pace. Some of these systems only protect the content item(s) against illegal copying, while others are also prohibiting the user to get access to the content item(s). The first category is called Copy Protection (CP) systems. CP systems have traditionally been the main focus for consumer electronics (CE) devices, as this type of content protection is thought to be cheaply implemented and does not need bidirectional interaction with the content provider. Some examples are the Content Scrambling System (CSS), the protection system of DVD ROM discs and DTCP (a protection system for IEEE 1394 connections).

The second category is known under several names. In the broadcast world, systems of this category are generally known as conditional access (CA) systems, while in the Internet world they are generally known as Digital Rights Management (DRM) systems.

A home network can be defined as a set of devices that are interconnected using some kind of network technology (e.g. Ethernet, IEEE 1394, BlueTooth, 802.11b, 802.11g, etc.). Although network technology allows the different devices to communicate, this is not enough to allow devices to interoperate. To be able to do this, devices need to be able to discover and address the functions present in the other devices in the network. Such interoperability is provided by home networking middleware. Examples of home networking middleware are Jini, HAVi, UPnP (Universal Plug and Play), AVC.

The concept of Authorized Domains (ADs) (being one type of DRM systems) aims at finding a solution to both serve the interests of the content owners (that want protection of their copyrights) and the content consumers (that want unrestricted use of the content item(s)). The basic principle is to have a controlled network environment in which content can be used relatively freely as long as it does not cross the border of the authorized domain. Typically, authorized domains are centered around the home environment, also referred to as home networks. Of course, other scenarios are also possible. A user could for example take a portable device for audio and/or video with a limited amount of content with him on a trip, and use it in his hotel room to access or download additional content stored on his personal audio and/or video system at home. Even though the portable device is outside the home network, it is a part of the user's authorized domain. In this way, an (device-based) Authorized Domain (AD) is a system that allows access to content by devices in the domain, but not by any other devices. Authorized Domains that are person-based and hybrid solutions do also exist.

For a more extensive introduction to the use of an Authorized Domain, etc., see S. A. F. A. van den Heuvel, W. Jonker, F. L. A. J. Kamperman, P. J. Lenoir, Secure Content Management in Authorised Domains, Philips Research, The Netherlands, IBC 2002 conference publication, pages 467-474, held at 12-16 Sep. 2002.

There are several prior art implementations and variations of an AD. For more information on an authorized domain architecture and implementation options, the reader is referred to European patent application serial number 01204668.6 (attorney docket PHNL010880) by the same applicant and incorporated herein by reference or European patent application serial number 02076998.0 (attorney docket PHNL020455) also by the same applicant and incorporated herein by reference. European patent application serial number 02076998.0 (attorney docket PHNL020445) more specifically describes an implementation in which content and devices are coupled to a domain. Additionally, European patent application serial number 02079390.7 (attorney docket PHNL021063) by the same applicant describes an implementation in which content is coupled to persons which then are grouped into a domain.

Further, a hybrid device and person based Authorized Domain (AD) is disclosed in European patent application serial number 03102281.7 (attorney docket PHNL030926) by the same applicant and incorporated herein by reference.

Authorized Domain DRM systems usually have one very typical characteristic. Namely, that the right(s) to a given content item usually differ depending on the device the content is being accessed on and the state of the device. As examples: it may depend on the type of device, where it is located (i.e. inside or outside an AD), what it is connected to, which users have authenticated themselves to the device, etc. More rights are typically granted in the case that the content is accessed on a device within the domain than when the content is accessed on a device outside the domain (which typically requires a copy of the content item). As examples of rights granted on a device within the domain is e.g. copying, distributing to other devices (within the domain), access for several users and/or the like. As examples of rights granted on a device outside the domain is e.g. (limited) access/rendering/viewing only (i.e. no copy), access only for a specific user, no distribution to other devices, and/or the like.

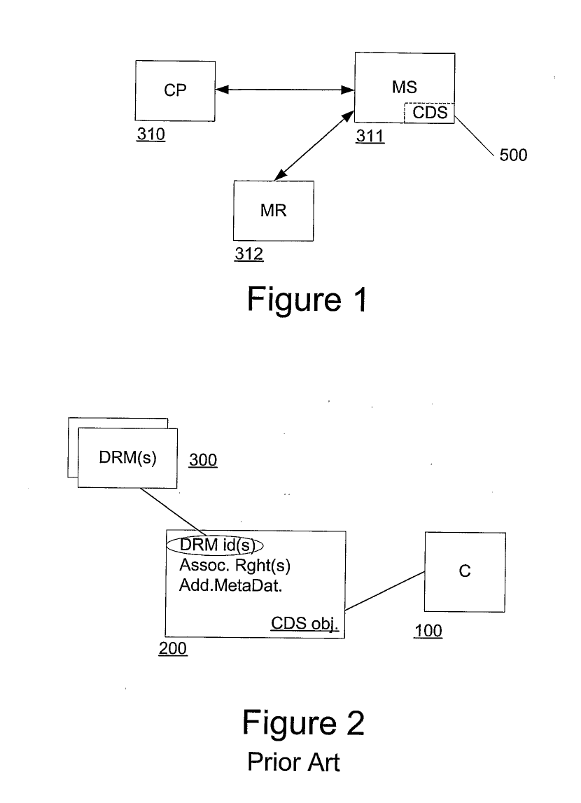

UPnP (see e.g. www.UPnP.org) is adding support of DRM protected content. Identification of the DRM system(s) that protect a given content item is done using a DRM identifier, which will be part of the description of a content item in a CDS (Content Directory Service) metadata object. Additional metadata in the CDS object will indicate the associated rights for the given content item. The CDS object may e.g. also comprise metadata like a name of an artist, a physical location of a file, etc. in addition to the available rights. See e.g. www.UPnP.org and the description of FIGS. 1 and 2 for further details.

However, there is currently no simple and efficient way to represent Authorized Domain (AD) content restrictions within an UPnP environment.

Additionally, there is a need for a simple implementation that allows easy identification of a specific Authorized Domain (AD) that a given content item belongs to. Preferably, this simple implementation should not require any changes for UPnP environments that do not support Authorized Domains.

Further, there is a need for an easy implementation of additional information, state information, etc. in relation to a content item of a DRM system, where that information can be used by a media content system/method to provide the optimal or the most flexible options with respect to access to the given content item (using the associated rights) when the given rights related to the content item may differ depending on the state or situation of the DRM content. The state may e.g. be which person is designated owner of the content item, which device is the content item stored on, which device is being used to render the content item, etc.

Additionally, presentation, to a user, of specific rights that are available at a given point in time is enabled, taking the AD and other aspects into account, without the need for the control device to have knowledge of the AD system specifics.

It is an object of the invention to provide a content media device (and corresponding content media method) that solves the above-mentioned shortcomings of prior art as well as others. A further object is to provide this in a simple, flexible and efficient way.

These objects, among others, are achieved by a device for (and corresponding method of) providing a content listing comprising a data structure comprising a content listing representing a number of media content items, where a media content item is represented two times by a first and a second (or additional) representation if said media content item belongs to a specific Digital Rights Management system (DRM) protecting said media content item, where said first representation comprises an identifier of the type of Digital Rights Management system (DRM) that protects said media content item, and said second (or additional) representation comprises said first representation and additional information relating to the identification and/or a state of the specific Digital Rights Management system (DRM) that said media content item belongs to.

In this way, handling of access to a given content item when the given rights related to a content item may differ depending on the state or situation of the DRM content is obtained, since information relating to this may be implemented in the second (or additional) representation (forth only denoted second representation). Further, it is also possible to provide a single implementation (comprising at least two representations) that can be handled as optimally as possible by both aware and unaware control points (see later for definition of an aware/unaware control point). A control point unware of the specific DRM system that said media content item belongs to (i.e. a unware control point) can detect from a rendering device the DRM system (and associated states) the rendering device supports and present to the user those combinations that apply to the given situation. This allows the ‘source’ of the media content to indicate the different options and the ‘sink’ to indicate what options apply. As an unaware control point cannot detect that the first and second representation represent different representations of the same DRM system, then multiple entries are presented to the user. An aware control point can detect that the different entries (i.e. as given by the first and second representation) correspond to the same DRM system whereby the most optimal case may be presented to the user.

In a preferred embodiment, the first representation is done using a DRM identifier indicating the type of DRM that protects the content, and the second representation is done using a DRM identifier equal to the first representation and, in addition, using a domain identifier that indicates the specific Authorized Domain (AD) the given content item is linked or belongs to.

In an alternative embodiment, (e.g. in the case of a hybrid or person based AD system), the second representation is done using an additional representation using a DRM identifier equal to the first representation and, in addition, using a person identifier that indicates the owner of the given content item.

In yet another embodiment, (e.g. in the case of DRM systems with rights based on device characteristic), the second representation is done using a DRM identifier equal to the first representation and, in addition, using a device characteristic of the rendering device.

As examples of device characteristics are e.g. availability of secure time (i.e. time elapsing where tampering by an application/user is not possible), digital outputs, storage capability, security level of the device or part of the device.(, etc.

Further, in some implementations/embodiments combinations of the three above examples maybe used (e.g. second representation comprising, in addition to the first representation, a person identifier that indicates the owner of the given content item and a device characteristic of the rendering device, etc.

Advantageous embodiments of the method according to the present invention are defined in the sub-claims and described in detail in the following. The embodiments of the method correspond to the embodiments of the device and have the same advantages for the same reasons.

Further, the invention also relates to a computer readable medium having stored thereon instructions for causing one or more processing units to execute the method according to the present invention.

These and other aspects of the invention will be apparent from and elucidated with reference to the illustrative embodiments shown in the drawings, in which:

FIG. 1 schematically illustrate a control point device (CP), a media server device (MS) implementing CDS and a media renderer device (MR);

FIG. 2 schematically illustrates a relationship between a CDS object, at least one DRM system and a given content item according to prior art;

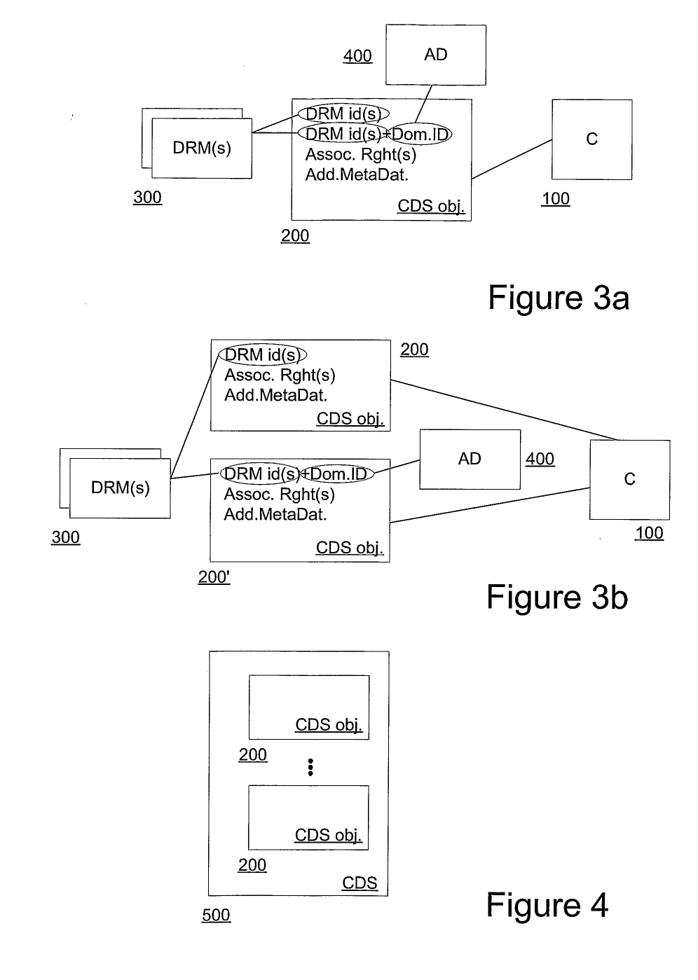

FIG. 3a schematically illustrates a relationship between a CDS object, at least one DRM system and a given content item according to one embodiment of the present invention;

FIG. 3b schematically illustrates a relationship between a CDS object, at least one DRM system and a given content item according to another embodiment of the present invention;

FIG. 4 illustrates a CDS comprising a number of CDS metadata objects;

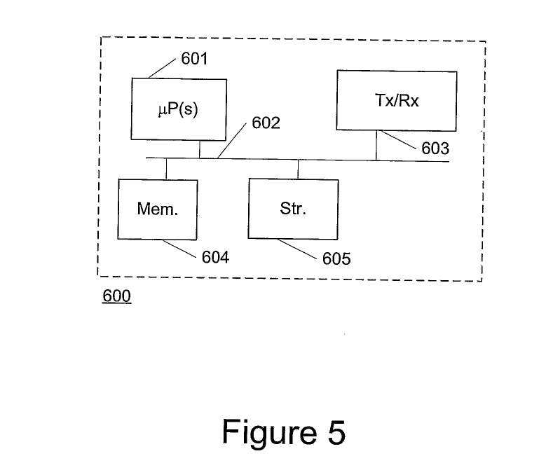

FIG. 5 illustrate a schematic block diagram of a control point device (CP), a media server device (MS) or a media renderer device (MR).

Throughout the figures, same reference numerals indicate similar or corresponding features. Some of the features indicated in the drawings are typically implemented in software, and as such represent software entities, such as software modules or objects.

FIG. 1 schematically illustrate a control point device (CP), a media server device (MS) implementing CDS and a media renderer device (MR). Shown are a control point device/service (CP) (310) (hereinafter only referred to as device) controlling the relevant process(es), a media server device/service (MS) (311) (hereinafter only referred to as device) implementing a content directory service (CDS) (500) (see also FIG. 4) and a media renderer device/service (MR) (312) (hereinafter only referred to as device) where content is to be handled and rendered according to UPnP and the present invention. These three different devices may, as an example, constitute a home network although the home network may comprise further devices, e.g. several media renderers, several media servers, etc. As another example, the control point (310) functionality may be included in the media server device (MS) or the media renderer (MR) instead of in a specific device for that purpose only.

The home network may also comprise one or more stand-alone user interface (UI) devices (not shown), e.g. a remote controller, a (wireless) PDA or tablet pc, etc. Typically, the UI device communicates with a control point device or is, more often, integrated with the control point device. Alternatively, it may also be integrated into a media renderer and/or a media server device.

According to UPnP, a media renderer (MR) (312) is used in conjunction with one or more media server devices (MS) (see below) to allow a control point (CP) (see below) to render content items (e.g. video, music, images, etc.) that are discovered on a media server device within the home network, i.e. to render a given content item that is physically present in or reachable by the home network. A media renderer device is a device that provides the functionality of rendering audio and/or video and/or other content items from the network. As will be explained, the content item does not necessarily need to be present on the specific renderer device.

The media renderer also provides a set of relevant rendering controls so that a control point can control how the given content is rendered. This comprises for example controlling features such as brightness, contrast, volume, stop, play, pause, fast forward, etc.

As examples of media renderer devices are both traditional devices like TVs, stereo/surround systems, radios, etc. and digital devices such as MP3 players, set-top boxes, PVRs, CD/DVD players, PCs, PDAs, Electronic Picture Frames (EPFs), harddisk based VCRs, etc.

According to UPnP, a media server device (MS) (311) is a device that presents media content to other (control point) devices on the home network. It shows the content via a Content Directory Service (CDS) and can preferably handle any specific type of media, any data format and any transfer protocol that is relevant for the home network. The content may be stored on the media server device or on other devices within the network or outside the network, e.g. as external content accessible via a network, the Internet, etc.

The media server (MS) is used in connection with one or more media renderer devices and enables a control point to discover content on the media server device and to render that content on any appropriate media renderer device within the home network.

As examples of media server devices (where some also could or do function as renderer devices) are e.g. traditional devices such as (harddisk based) VCRs, CD/DVD players, audio-tape players, still-image cameras, camcorders, radios, TV tuners, set-top boxes, etc. and newer digital devices such as MP3 servers, PVRs, Home Media Servers (like a PC e.g. comprising a wide variety of content like MPEG2 video, CD audio, MP3 and/or WMA audio, JPEG images and so on), etc.

The media server typically contains a significant portion of the home owner's/the user(s) of the home network's content.

Such media server and renderer devices typically support various content formats in one form or another (where the formats may be overlapping, different and/or the same from device to device). By using and implementing CDS, the content stored on the media server(s) is exposed to the home network in a uniform and consistent manner.

The CDS implemented in the media server device presents a number of CDS objects or items (not shown; see e.g. FIGS. 2, 3a and 3b), where a single CDS object or item (forth only denoted object) typically exists for each content item or content directory, where the CDS object is used to provide access to the content item and further comprises metadata describing relevant information relating to the given content item, as explained in greater detail in connection with FIG. 2 and according to the present invention in connection with FIGS. 3a and 3b.

In short, the CDS provides a uniform mechanism for allowing devices implementing a control point to browse and search the content in the home network and to obtain detailed information about individual content objects.

The CDS additionally provides lookup/storage service allowing clients (e.g. UI devices) to locate and perhaps store individual content items that the media server is capable of providing. For the kinds of devices that contain content items of different formats (e.g. MP3, MPEG2, JPEG, etc.) a single CDS object can be used to keep track of all the content items regardless of their type.

Further, for each content item that is referenced by the CDS, the relevant CDS object also include information about the transfer protocol(s) and file format(s) that the media server device can use to transfer the content to the relevant media renderer device. This includes information related to the DRM system protecting the content and the rights a user can expect when using this content.

According to UPnP, a control point device (CP) (310) is a device for controlling the process(es) of handling the interaction between the media server device and one or more media renderer devices, when content in the home network is to rendered on one of those. After rendering of a given content item is initiated, the control point device controls the flow of the content (e.g. play, pause, stop, seek, etc.) typically using input from a UI device. The actual transfer of the content item to the renderer device is set up by the control point device but it is not performed by the control point but instead by the media server device.

In the following, the process of obtaining and rendering a given content item involving a control point device, a media server device and a renderer device will be given.

The control point device will use the media server's CDS to locate the content item to be rendered. After the desired content has been identified, the control point needs to determine which transfer protocol and data format should be used to transfer the content from the media server to the media renderer device. Examples of transfer protocols are e.g. IEEE-1394, HTTP GET, RTSP/RTP, etc., and examples of data formats are e.g. image/jpeg, image/gif, audio/mpeg, video/mpeg, video/MP4V-ES, etc. (see e.g. http://www.isi.edu/in-notes/iana/assignments/media-types/media-types). The control point makes this determination by comparing the content's protocol/format information (obtained via the media server's CDS) with protocol/format information obtained from the media renderer.

After the transfer protocol and data format have been identified, the control point informs each device that the specified protocol/format are about to be used. Depending on which type of transfer protocol was selected, either the media renderer device or media server device will return an instance ID to the control point device. This instance ID is used by the control point to control the flow of the content (e.g. Play, Pause, Stop, Seek, etc). For some types of transfer protocols (e.g. for devices that only support HTTP GET), it may be the situation that the control point is not able to obtain an instance ID from either device. When this happens, the control point uses an instance ID of 0 (zero) which can be handled differently.

As mentioned, a content item in such a home network may be protected by a DRM system and/or an Authorized Domain (AD) DRM system.

However, there is currently no simple and efficient way to represent Authorized Domain (AD) content within an UPnP environment.

Further, there is a need for a simple implementation that allows easy identification of a specific Authorized Domain (AD) that a given content item belongs to. Additionally, this simple implementation should preferably not require any changes for UPnP environments that do not support Authorized Domains.

According to the present invention, a content item that is protected by an Authorized Domain (AD) DRM system is represented twice, by a first and a second representation. See FIGS. 3a and 3b and related description for different embodiments.

The first representation is done using a DRM identifier indicating the type of DRM that protects the content. This is similar to what is done according to FIG. 2.

The second representation is done using a DRM identifier equal to the first representation and, in addition, using a domain identifier that indicates the specific Authorized Domain (AD) the given content item is linked or belongs to (see FIGS. 3a and 3b).

In an alternative embodiment, (e.g. in the case of a hybrid or person based AD system), the second representation is done using an additional representation using a DRM identifier equal to the first representation and, in addition, using a person identifier that indicates the owner of the given content item.

In another embodiment, (e.g. in the case of DRM systems with rights based on device characteristic), the second representation is done using a DRM identifier equal to the first representation and, in addition, using a device characteristic of the rendering device.

As examples of device characteristics are e.g. availability of secure time (i.e. time elapsing where tampering by an application/user is not possible), digital outputs, storage capability, security level of the device or part of the device, etc.

Further, in some implementations/embodiments combinations of the three above examples may be used (e.g. second representation comprising, in addition to the first representation, a person identifier that indicates the owner of the given content item and a device characteristic of the rendering device, etc.).

Preferably, the first and the second representations are implemented as strings.

In addition, each representation will indicate the rights (informative), that a user can expect to have when the content is used according to that DRM identifier.

In this way, an Authorized Domain/DRM aware control point, i.e. a control point implementing functionality enabling proper identification and handling of Authorized Domains according to the present invention, can see both the first and second representations for a given content item and will be able to deduct in a very simple manner that it represents different aspects of a single DRM system. It will recognize the DRM identifier as an Authorized Domain identifier and know that the other part (i.e. the second representation) represents the identifier of a specific Authorized Domain, i.e. the specific Authorized Domain (AD) the given content object is part of. This will allow the system to present the content with a single entry in the UI using the optimal (or sum of) the available rights.

An Authorized Domain/DRM unaware control point, i.e. a control point that does not implement functionality enabling proper identification and/or handling of Authorized Domains, see the first and the second representation but can only derive that the content is protected by two different DRM systems, since the representations are different and an AD unaware control point do not now the internal structure/format of the second representation. But even when unaware of the invention presented in this document, the system will still be able to determine the rights that most likely are available when the content is access on a device presenting the same DRM identifier.

The DRM info, i.e. the first and second representations, may be provided to the control point as part of the procedure when the control point determines which transfer protocol should be used for transfer of the content item, as described above. Alternatively, it may be provided to the control point using a dedicated call to a media renderer device.

The standard way to determine whether the media server device and the media renderer device support the same protocol is to compare strings (using * as a wildcard), whereby the first and second representations also will be provided (if part of the procedure of determining the transfer protocol).

In the case of multiple representations of the same DRM system, the control point can choose the DRM representation with the most advantages.

For DRM systems in this context, there are two possibilities. Either, the specific media renderer device and the media server device is part of the same AD or they are part of different ADs. If the devices are part of different domains then only the first DRM indication (i.e. the first representation) will match. If the devices are part of the same domain both the first and second DRM indication (i.e. the first and second representation) will match. And the control point will now that the rights indicated with the second representation apply for communication between these two devices.

This is due to the nature of ADs that content typically can be played and/or copied freely or at least more freely within an AD, while rights are far more limited between domains.

It is to be understood that although reference has been made to UPnP, the present invention and its embodiments described in connection with all the Figures is just as applicable to non UPnP systems like other middleware and/or web systems, where DRM systems are involved.

FIG. 2 schematically illustrates a relationship between a CDS object, at least one DRM system and a given content item according to prior art. Shown are one or more DRM systems (300), a CDS object (200) and a given content item (C) (100) e.g. according to the UPnP specification. Typically one CDS object (200) exists for each content item (C) in a given home network or other type of network and a CDS (not shown) typically comprises several CDS objects (200).

Identification of the type or kind of DRM system(s) (300) that protect a given content item (100) is done using a DRM identifier (DRM id(s)) as indicated by a line on FIG. 1. The DRM identifier is part of the description of the given content item (100) in the CDS (Content Directory Service) metadata object (200). Further metadata in the CDS object (200) may indicate or specify the associated rights (Assoc. Rght(s)) for the given content item (100). The rights associated with a given content item may e.g. specify copy once, render only 5 times, European market only, etc.

The CDS object (200) may e.g. also comprise additional metadata (Add.MetaDat.) like a name of an artist, a physical location of a file, etc. in addition to the available rights.

In this way, a CDS object for a given content item is used to describe the type of DRM system that protects it while specifying the associated rights e.g. together with additional information. A CDS comprising several CDS objects accordingly functions as a content listing.

FIG. 3a schematically illustrates a relationship between a CDS object, at least one DRM system and a given content item according to one embodiment of the present invention. Shown are one or more DRM systems (300), a CDS object (200) and a given content item (C) (100) according to the present invention. The embodiment of FIG. 3a corresponds to the one of FIG. 2 with the exceptions as explained in the following.

According to the present invention, a content item that is protected by a DRM system (e.g. an Authorized Domain (AD) DRM system) is represented twice. In this embodiment, the content item is represented twice in the same CDS object (200). Grouping all DRM representations in one CDS object will save space and a control point will realize that they present different representations of the same content and can optimize its UI to reflect this.

Alternatively, it may be represented in two different CDS objects, as described in connection with FIG. 3b.

The first representation is done using a DRM identifier (DRM id(s)) indicating the type of DRM that protects the content. This is similar to what is done according to FIG. 2.

The second representation comprises a DRM identifier (DRM id(s)) equal to the first representation and, in addition, a domain identifier (Dom.ID) that indicates the specific Authorized Domain (AD) (400) the given content item is linked or belongs to.

As a specific example of such a first representation is e.g.:

DRM id: com.Philips.drm.AdDrm

As a specific example of such a second representation is e.g.:

DRM id+Dom.ID: com.Philips.drm.AdDrm(Domain786487321)

As mentioned earlier, the second representation may also comprise a person identifier that indicates the owner of the given content item and/or a device characteristic of the rendering device, etc.

FIG. 3b schematically illustrates a relationship between a CDS object, at least one DRM system and a given content item according to another embodiment of the present invention. This embodiment correspond to the one shown in FIG. 3a with the exception that instead of the first and the second representation being embedded in a single CDS object (200) (as is the case of FIG. 3a) then the first representation is embedded in one CDS object (200) and the second representation is embedded in another CDS object (200′).

FIG. 4 illustrates a CDS (500) comprising a number of CDS metadata objects (200) whereby the CDS (500) function as a content listing.

FIG. 5 illustrate a schematic block diagram of an embodiment of a control point device (CP) or a media server device (MS) or a media renderer device (MR). Shown is a control point device (CP) or a media server device (MS) or a media renderer device (MR) comprising one or more specialized and/or generalized micro processors (601) implementing the functionality as described in connection with the present invention, which is connected via a bus or similar data communication structure (602) with a memory (604), a storage (605) and transmitter/receiver (603) for storing and communication of information, data, etc., respectively, according to the present invention.

In the claims, any reference signs placed between parentheses shall not be constructed as limiting the claim. The word “comprising” does not exclude the presence of elements or steps other than those listed in a claim. The word “a” or “an” preceding an element does not exclude the presence of a plurality of such elements.

The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A device providing a content listing including a data structure, comprising:
a content listing representing a number of media content items,
wherein a media content item is represented simultaneously in the content listing by a first representation and a second representation if said media content item is protected by a Digital Rights Management system,
said first representation including an identifier of the type of the Digital Rights Management system, and
said second representation including said first representation and additional information relating to the identification or a state of the Digital Rights Management system.

2. A device according to claim 1, characterized in that said Digital Rights Management system is an Authorized Domain, and wherein said additional information comprises an identifier that uniquely identifies the authorized domain.

3. A device according to claim 1, characterized in that said additional information comprises a person identifier that indicates the owner of the given content item or a device characteristic of a rendering device used for rendering said media content item.

4. A device according to claim 1, characterized in that said device is a media server device according to the Universal Plug and Play (UPnP) specification.

5. A device according to claim 1, characterized in that said data structure is implemented by a content directory service (CDS) according to the Universal Plug and Play (UPnP) specification.

6. A device according to claim 5, characterized in that said first representation and said second representation are implemented in
the same content directory service object, or
two different content directory service objects.

7. A method of providing a content listing including a data structure, comprising:
providing a content listing representing a number of media content items, and
simultaneously representing a media content item by a first representation and a second representation if said media content item is protected by a Digital Rights Management system wherein
said first representation comprises an identifier of the type of Digital Rights Management system, and
said second representation comprises said first representation and additional information relating to the identification or a state of the specific Digital Rights Management system.

8. A method according to claim 7, characterized in that said Digital Rights Management system is an Authorized Domain, and wherein said additional information comprises an identifier that uniquely identifies the authorized domain.

9. A method according to claim 7, characterized in that said additional information comprises a person identifier that indicates the owner of the given content item or a device characteristic of a rendering device used for rendering said media content item.

10. A method according to claim 7, characterized in that said device is a media server device according to the Universal Plug and Play (UPnP) specification.

11. A method according to claim 7, characterized in that said data structure is implemented by a content directory service (CDS) according to the Universal Plug and Play (UPnP) specification.

12. A method according to claim 11, characterized in that said first representation and said second representation and implemented in
the same content directory service object, or
two different content directory service objects.

13. (canceled)

14. A computer readable medium having stored thereon instructions for causing one or more processing units to provide a content listing including a data structure, comprising:
providing a content listing representing a number of media content items; and
simultaneously representing a media content item by a first representation and a second representation if said media content item is protected by a Digital Rights Management system, wherein said first representation comprises an identifier of the type of Digital Rights Management system, and said second representation comprises said first representation and additional information relating to the identification or a state of the specific Digital Rights Management system.
